(19) United States
(12) Patent Application Publication
(10) Pub. No.: US 2005/0160013 A1
(43) Pub. Date: Jul. 21, 2005

(54) System and method for organization and display of data using identification of key data for comparison and analysis

(76) Inventors: Diane Schechinger, Half Moon Bay, CA (US); David Fennell, Redwood City, CA (US)

Correspondence Address: DIANE SCHECHINGER, 441 ALAMEDA AVE, HALF MOON BAY, CA, 94019, US

(21) Appl. No.: 11/034,355

(22) Filed: Jan. 13, 2005

Related U.S. Application Data
(60) Provisional application No. 60/536,806, filed on Jan. 16, 2004.
(60) Provisional application No. 60/536,805, filed on Jan. 16, 2004.
(60) Provisional application No. 60/547,177, filed on Feb. 25, 2004.
(60) Provisional application No. 60/578,332, filed on Jun. 10, 2004.
(60) Provisional application No. 60/578,357, filed on Jun. 10, 2004.

(51) Int. Cl. G06F 17/60

(52) U.S. Cl. 705/26; 705/27; 707/3

(57) ABSTRACT

The use of computer technology and the internet to quickly locate, view, compare, and select marketable products or other data arranged according to selected Key Parameters. The growth of the internet has exceeded the capacity of existing technologies and business methods to allow business and consumer users to sort through a vast sea of data. Variable Field Names expressed as Key Parameters builds upon the simple concept of organizational hierarchy, and enables the manipulation of data in a specific manner through the internet to the marketplace, in which all conceivable products, whatever their use or country of manufacture, can be located, reviewed, compared, and selected for purchase. The invention uses a hierarchy-based software system that will allow the computer user to search and find required data directly. This invention is a system and method of identifying, selecting and displaying Key or most important attributes or parameters associated with each product Type. The user will no longer waste time sifting through search results that are not germane to his needs or are outside the needs of his current search.

### CROSS-REFERENCE TO RELATED APPLICATIONS

A. World.info PPA #3, “Schechinger/Fennell System and Method for Organization and Display of Data and Identification of Key Data for Comparison and Analysis,” filed Jan. 16, 2004, PTO Appl. No. 60/536,806 (Note: This is the PPA for the present RPA.)
B. World.info PPA#1, “Schechinger/Fennell System and Method for Categorization of Data,” filed Jul. 14, 2003, PTO Appl. No. 60/487,395
C. World.info RPA #1, “Fennell Hierarchy for Marketable Product Categorization,” filed Jul. 12, 2004, PTO application Ser. No. 10/889,374. (This is the RPA for PPA Appl. No. 60/487,395 above. Note change in Title wording.)
D. World.info PPA #2, “Schechinger/Fennell System and Method for Data Display Using Variable Field Headings,” filed Jan. 16, 2004, PTO Appl. No. 60/536,805.
E. World.info RPA #2, “System and Method for Data Display Using Variable Field Names,” filed (mailed) Jan. 10, 2005.
F. World.info PPA #4, “Schechinger/Fennell System and Method for Filtering Search Results by Utilizing User-Selected Parametric Values from a Self-Defined Drop-Down List on a Website,” filed (mailed) Feb. 23, 2004, no PTO # on file
G. World.info PPA #5, “Schechinger/Fennell System and Method for filtering Data Search by Utilizing User Selected Checkboxes, filed Feb. 25, 2004, PTO Appl. No. 60/547,177
H. World.info PPA #6, “Schechinger/Fennell/Hirzel System and Method for Associating Unlimited Numbers of Parametric Names and Values to a Specific Product and the Ability to Select or Deselect for Viewing the Results on a Parametric Display Page,” filed Jun. 10, 2004, PTP Appl. No. 60/578,332
I. World.info PPA #7, “Schechinger/Fennell System and Method for Finding Specific Products that Meet Exact User Defined Requirements in Three Clicks.” Filed Jun. 10, 2004, PTO Appl. No. 60/578,357

### BACKGROUND OF THE INVENTION

1. Field of the Invention

This invention relates to, but is not limited to, the use of computer database and software technology and the internet to locate, view, compare, and select marketable products or other data.

2. Prior Art

Since the advent of the personal computer, the internet has truly become the “World-wide web,” with terminals in every nation linked to each other sharing information and transmitting data in quantities and at speeds undreamed of even a decade ago. The growth of the internet has exceeded the capacity of existing technologies and business methods to allow business and consumer users to access, compare, and sort items of a like kind in a comprehensible manner from this vast ocean of unorganized data.

Existing methods of filtering information from computer databases, commonly known as “search engines,” which can be found in websites such as “Google.com,” “Vehix.com,” “Globalspec.com,” and others, are either too nonspecific, or too restrictive in their approach, and do nothing meaningful to organize the countless reams of marketing data into an instantly usable and understandable format. Using the current art, once the user has entered such a site, he is obliged to navigate, using the familiar “point-and-click” process, through a varying number of discrete steps, from the website's home page, through that site's unique system of organization. Eventually, he may find that product whose combination of features and attributes meets his needs, most frequently in a multitude of clicks. The user often gets lost in the complex site navigation unique to each website, having never found the products of interest. It is at best a laborious, inefficient process, yielding doubtful results.

### OBJECTS AND ADVANTAGES

A. The inventions referenced above (PPAs and RPAs listed in Section II above) create a format by which all products of all types may be displayed in one common layout, for comparison and contrast by specific parameters or attributes of interest to the User. In the present invention, the display itself is simplified by the fact that some attributes will be of more interest or value to the User than others for comparison, and consequently only those attributes need be displayed. The work of seeking out specific product types for comparison of key specifications and purchase by purchasing agents, engineers, and designers, and others is thereby rendered more efficient.

B. The use of software technology enables the manipulation of groupings of key, or most important to a particular application, variable field names “Key Parameters 1 Name”, “Key Parameters 2 Name”, “Key Parameters n Name . . . ” (see IID and IIE above) to be associated on single-page display layouts “Key Specifications 1 Page,” “Key Specifications 2 Page,” “Key Specifications n Page . . . . ” instead of the fixed parameter groupings used in the current art. This allows a search and display mechanism which is universally adaptable to any product type or any other commercial or non-commercial use.

C. An important part of this patent is the generic quality of the Key Specification grouping, so that it is useable with many types of products. This patent is intended to include other generic names for parameters, attributes, or specifications groupings.

D. Page layouts for the Key Specifications may consist of as many pages as are required, or as many tabs (one for each subsequent page) as conveniently fit within the page width. There is no limit to the number of single-page layouts that may be required to adequately describe the parameters of a given product.

E. By making the Key Specifications a variable associated with products of same kind (apples to apples), parametric headings of interest can be determined and entered into the variable fields for those specific products or services.

F. The groupings for these parameters can be determined by the owner of the database and can be changed according to input from the end User. Alternately, the end User can select which groupings he wishes to view by selecting another page layout for the same product, or by selecting another product whose Key Specifications may be viewed within the same familiar page layout and navigation.

G. This invention is a system and method of identifying, selecting and displaying Key or most important attributes associated with a product type and has never been done.

H. The system can be used over the internet and will be accessible to end-users who have computers with internet access. Installation of software at computer terminals will not be required.

I. All products from all vendors are similarly displayed. This allows small business enterprise to compete on an equal footing with large corporations, encouraging innovation throughout the marketplace.

J. Further objects and advantages of the invention will become apparent from a consideration of the Figures and ensuing description.

### SUMMARY OF THE INVENTION

### Variable Held Parameters

The invention is a universally variable method of identifying, selecting and displaying products Key Parameters in a series of single-page layouts, by which the user can quickly refine his search to a short list of like products with Key similar parameters to be compared and contrasted. The use of software technology enables the manipulation of groupings of Key Parameters, those most important to a particular application, to be associated on single-page display layouts, instead of fixed parameter groupings as used in the current art. This allows a search and display mechanism which is universally adaptable to any product type or any other commercial or non-commercial use, and makes it possible for the User to easily find and compare items and parameters of like kind and like nature and usage. An important part of this patent is the generic quality of the Key Parameter grouping, so that it is useable with many types of products.

In the present invention, grouping of Key Parameters is used to further simplify data analysis. The application of identifying Key Parameters along with spreadsheet with variable heading display based on the product type in this manner as a method for displaying and comparing parameters has never been established.

### FIGURES

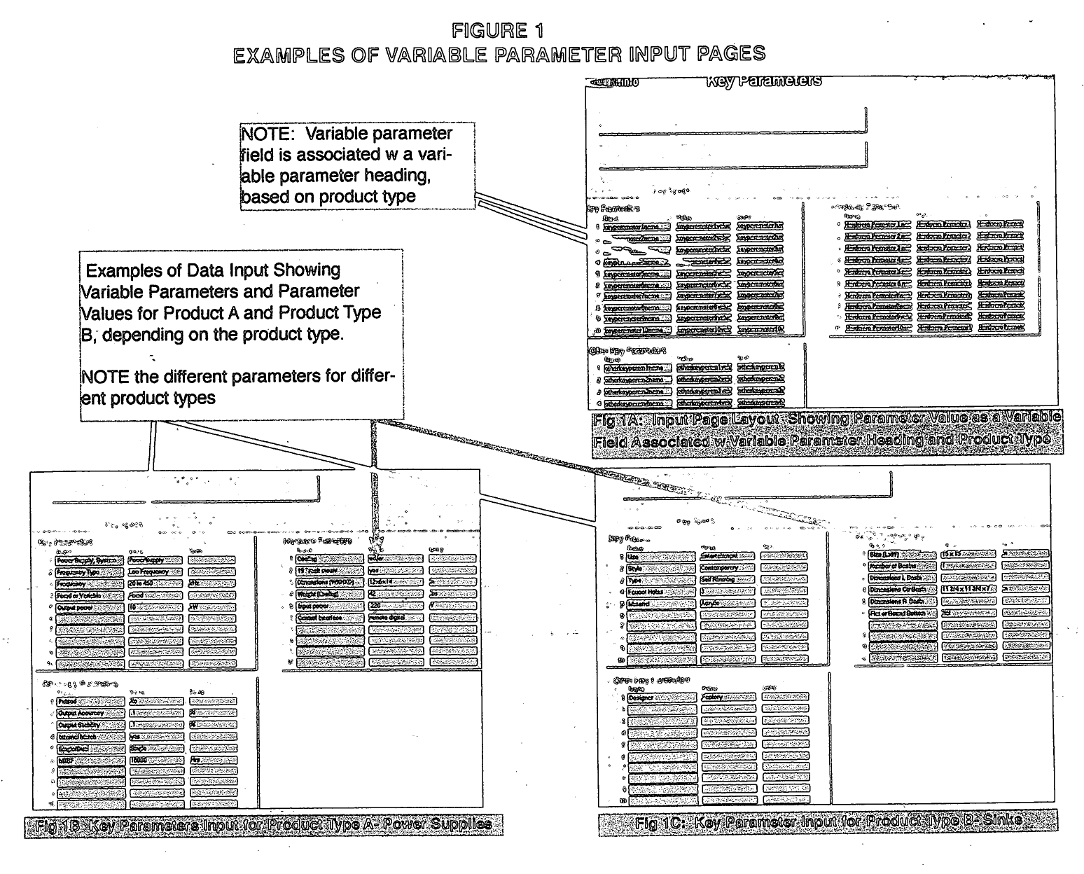

A. FIG. 1A: Generic input page showing variable parameter field headings

B. FIG. 1B: Key parameter input page for Product Type A

C. FIG. 1C: Key parameter input page for Product Type B

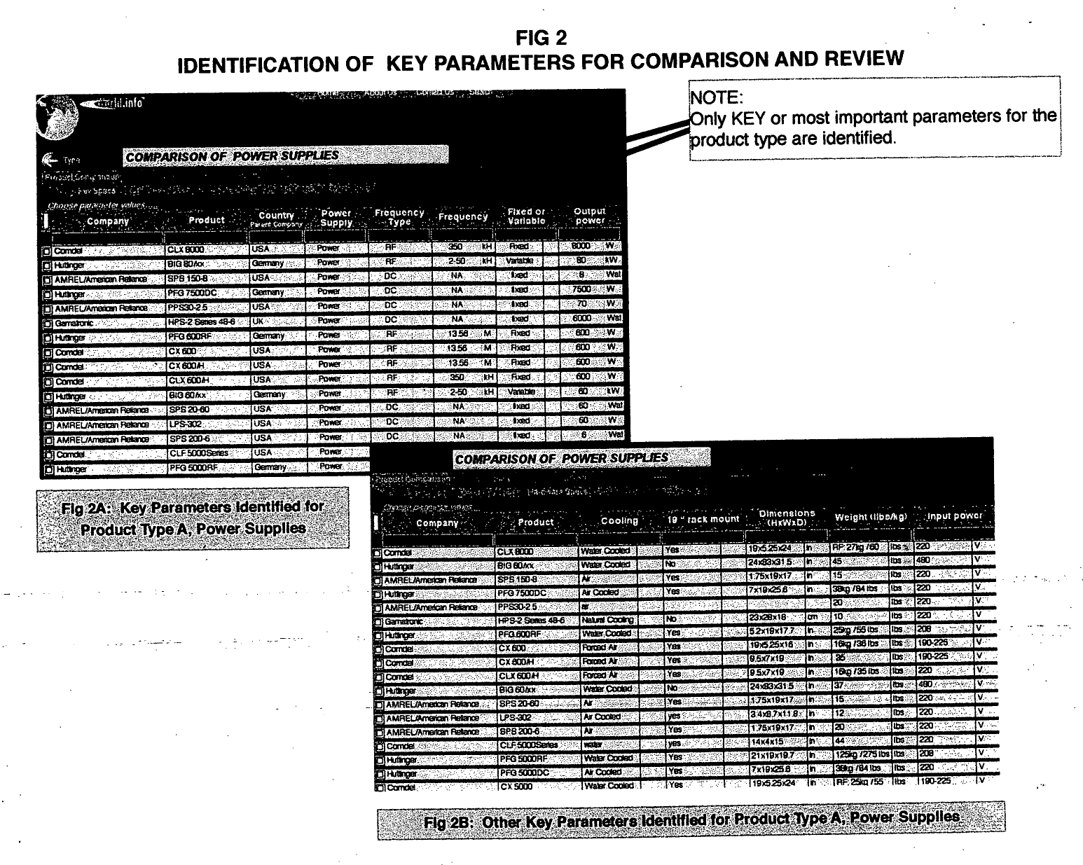

D. FIG. 2A: Key Parameters identified for Product Type A

E. FIG. 2B: Other Key Parameters identified for Product Type A

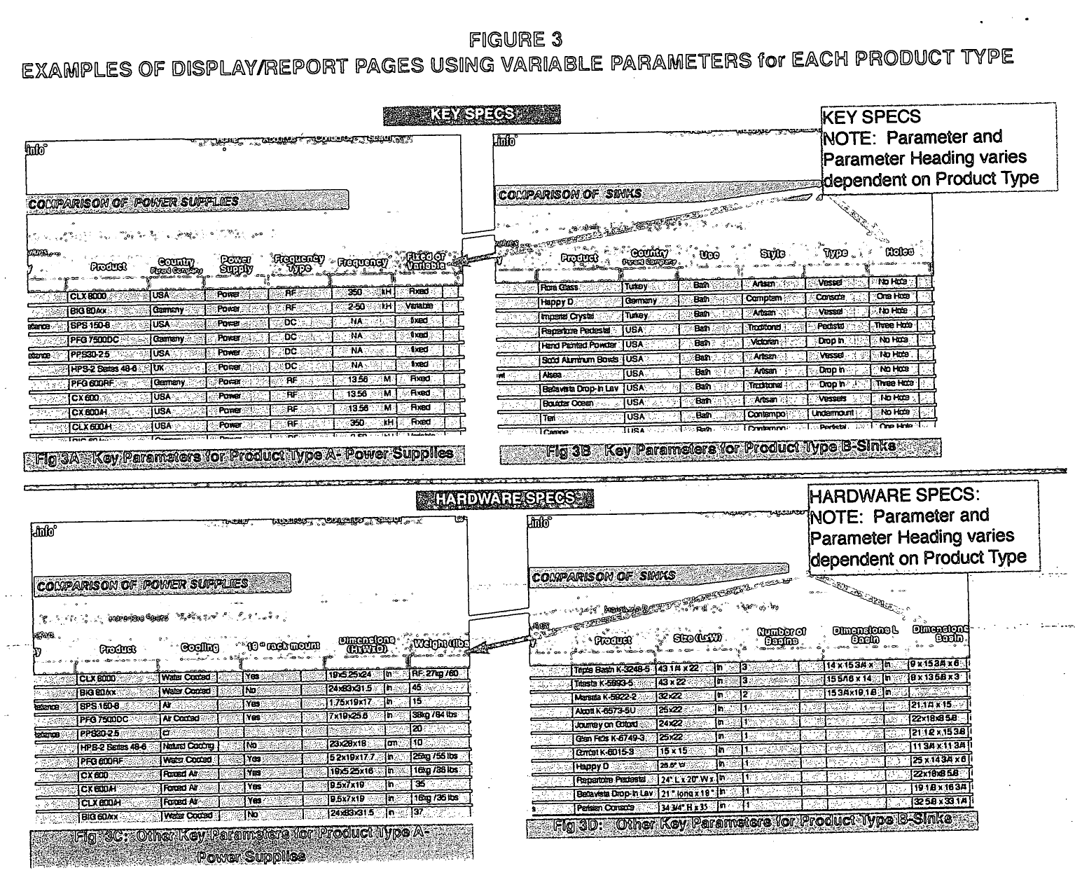

F. FIG. 3A: Display Page showing Key Parameters for Product Type A

G. FIG. 3B: Display Page showing Key Parameters for Product Type B

H. FIG. 3C: Display Page showing Other Key Parameters for Product Type A

I. FIG. 3D: Display Page showing Other Key Parameters for Product Type B

### DETAILED DESCRIPTION

The inventions referenced above (PPAs and RPAs listed in Section II above) create a format by which all conceivable products, whatever their use or country of manufacture, can be displayed on one common layout, to be compared and contrasted with other products of a like kind, according to various parameters of interest to the User. In the present invention, the display itself is simplified by the fact that some attributes will be of more interest or value to the User than others for comparison, and consequently only those attributes need be displayed. When used in conjunction with the World.info website database and search process referenced above, it enables the user to immediately determine exactly which products of a given type will match the particular combination of parameters or attributes he is seeking.

We have invented a system and method of identifying and grouping unlimited numbers of attributes in a way in which “apples-to-apples” comparisons of similar product parameters or attributes can be seen for contrast and comparison in an easy to use spreadsheet type of format. This is done by identifying various parameters which are key to evaluating a specific product type and displaying these variable parameters as associated groupings on a single page, or a series of single pages unlimited in number.

Our invention is a method of organizing and displaying data using variable fields in which one layout can be easily and endlessly modified according to preferences established in the program or by the end-User. This is accomplished by the use of our Variable Field Naming (IIA and IIB above) and the use of variable parameter fields, in which the product data is entered and displayed for comparison in one layout which can be used in an infinite number of ways. In this present patent application, we extend that idea to include the variable groupings of these variable parameter fields in the following manner.

Eighteen (not limited to 18) fields of key parameters or attributes are chosen for display using our Variable Field Name display (IIA and IIB above). One to 5 (not limited to 5) layouts are created in which headings are not fixed but are themselves variable values, whose value is associated with each record and is fixed for that Product Type (not limited to Type). By making the field heading a variable associated with products of same kind (apples to apples), parametric headings of interest can be determined and entered into the variable fields for those specific products or services, in groupings or associations. Such Key Parameterss may be grouped together on single pages focused on, for instance, performance specifications, hardware specifications, or purchase information, for a given product. There is no limit to the number or type of such associations or groupings that may be created.

The values and associations for these Key Parameters can be determined by the owner of the database and can be changed according to input from the end User. Alternately, the end User can select which parameters he wishes to view by selecting another page.

The invention can be used over the internet and will be accessible to end users who have personal computers with internet access. In this format, the end user will not require database software to be installed to access the data.

The user navigates quickly in 3 clicks (provisional patent above) through the hierarchy via the commonly used “point and click” computer technology until he has selected the product type of interest to him. Having arrived at the database of products specific to his needs, he then selects from among the pages of Key Parameters available for display, the specific parametric values available in pulldown lists of all the values available within any given field. In this manner, by selecting a unique combination of specific parametric values and clicking on the “Refine Search” button, he is presented with the short list of all products within the database for that Product Type that match his unique requirements.

The present invention is the identification of Key Parameters for display beneath the Variable Field Names used in this type of search and display mechanism. The term “Key Parameters” as used herein refers to those parameters or attributes recognized as being critical in the selection of a product under review. A given product may be represented as a unique combination of many, possibly hundreds, or even thousands, of attributes, but the final selection will be made based on a combination of a relative few. For example, simple drinking glass could be selected on a basis of size, diameter, length, weight, shape, material, capacity, color, place of manufacturing, customary use, breakability, opacity etc. A complex consumer product, such as a car, could have literally thousands of attributes by which the consumer might judge its suitability for his needs.

Our variable parameter feature recognizes that the purchaser of a given product is most interested in a relatively small number of attributes, a few “Key Parameters”, which are most likely to influence his decision as to which one of a number of products he will ultimately select. For instance, to the typical car buyer, mileage, engine size, roominess and color are of greater importance to him than what rim size, radio manufacturer, turn signal location or window tinting. He will seek out cars that meet the requirements that are his key parameters, before narrowing his search along other, less important, parameters. When used with the Fennell Hierarchy established in our patent (pending listed above), the end-user is given instant access to an “apples-to-apples” comparison of products by specific key or most important attributes, while avoiding the confusion resulting in a search in which all conceivable attributes are listed. Once his search has been narrowed to a manageable size, he can proceed to sort by other, less important, attributes.

After identifying the Key Parameters and groupings, the data is entered into variable attribute or parameter fields which are associated with the variable heading and the product type identified in the Fennell Hierarchy. The display of data varies depending on the product type.

This concept of identifying, selecting and displaying key or most important attributes associated with each product type has never before been done.

Product data is provided by the manufacturer or seller, in a data entry mechanism to be protected by a subsequent patent. Any new Product that is entered is immediately placed into its proper Product Type database(s) for ease of retrieval. Whenever a new product, service, or other item is entered into the database, Key Parameter Names associated with that product are entered into the database by either manual, semiautomatic, or fully automatic method to be the subject of a future PTO application. Different manufacturers of similar products may have differing ways of conceptualizing or displaying similar data; they may or may not have data available for a given field; they may not wish to make certain data available. For these and other reasons, the data for any given products may be entered in any number fields, not all of which need be on be visible on a display page. The data will exist within the database, as entered, but will only appear to the user if the Variable Field Name has been selected for display as a Key Parameter. When one Field Name on the display page has been replaced by another, by either the user or the owner of the display page, the data for that field will disappear, and the data associated with the new Field Name will appear in its place. In a similar manner, one Field may be moved from one page to another, to create a display layout configured by the user for his own convenience, according to his own view as to which parameters are critical to his selection.

In this manner the available data may be manipulated into varying displays by the user or the owner of the database. Once each item is in the database and has the appropriate values entered under the Key Parameter Names assigned to it, retrieving only the Key Parameter Values which apply to that specific item, and thus “apples-to-apples” comparisons with other like products, becomes possible.

The use of the term “product” as used in this patent application, while generally most useful in the marketplace arena to which the invention is primarily directed, is not intended to limit the scope of the invention to products only. The term “product” is construed to apply to any conceivable marketable item, object, service, performance, or idea. For example, its use includes, but is not limited to, such diverse items as the following: industrial or consumer products, fish ponds, county fairs, travel information, government contracts, international trade opportunities. The use of Variable Field Names and associated search mechanisms (referenced in the PPAs given in II above and others yet to be filed) may, within the scope of this patent application, be extended to other, noncommercial uses. The term “Parameter” as used in this application may also be and is not limited to being variously defined as “asset,” “attribute,” “capacity,” “specification,” “value,” or “property.” This patent is intended to protect the business method of the use of the Variable Field Names selected for display as Key Parameters as described herein. Specific algorithms and programming language to enable the processing of this method will be filed in subsequent patents applications. The Figures showing the current configuration of the World.info website layouts are purely illustrative of its capacities, and may be altered in configuration and appearance without departing from the spirit and scope of the current invention. While our invention and its immediate most commercial viability concerns itself with variable parameter fields for product types, this method of organization is not considered to be limited to parameter fields for product types only but extends, under this provisional patent application, to all categories of hierarchical data entry and display,

Note that the Key Parameter display within the context of Variable Field Names, as used in conjunction with the Fennell Hierarchy, works from both ends, in that it (a) enables the buyer (user) to refine his search to satisfy his owns specific needs, and (b) enables the seller to have his product easily found and readily available to the user's search. It “levels the playing field,” reducing or eliminating the need for blanket advertising in the hopes of attracting new customers who might otherwise be unaware of the existence of his business or his products.

Note that, while the Key Parameter display is conceived as a function within the Variable Field Names in conjunction with the Fennell Hierarchy and associated PPAs referenced in II above, the use of this invention is not restricted to these systems and methods, but may be broadly applied in other unspecified search and display mechanisms. The reader will see that the extreme versatility of this method in describing any conceivable product, item, or service in terms of a few key parameters by which all similar items may be compared. The description contained within Section VII not to be construed as limiting the scope of the invention, but rather as an exemplification of one preferred embodiment thereof. Many other variations are possible, for example the description or definitions of travel and entertainment opportunities, real estate, catalogs of all kinds commercial and noncommercial. Accordingly, the scope of the invention should not be limited by the items listed above.

Unique systems and methods of navigation and display will be filed in subsequent patents.

1. A method of identifying, selecting, retrieving and displaying stored data of any kind, comprising:
a. a computer terminal connected to the internet,
b. a storage means for storing data on a digital or electronic storage medium,
c. an algorithmic logic circuit configured to prepare the storage medium to store the data,
d. an algorithmic logic circuit for locating the stored product and product specification data,
e. an algorithmic logic circuit by which the stored data may be associated with one or more field names or headings,
f. an algorithmic logic circuit for retrieval and display of located data in a user-manipulated spreadsheet display in a single- or multiple-page layout in which the fields as named or described by their various headings may be located at any place or no place within the spreadsheet display,
whereby specific data for a given item may be compared with like data for other items of a like kind, without the restrictions imposed by a fixed layout for fixed fields, by means of infinitely manipulable fields, each with its own associated data records, which may be displayed in infinitely variable groupings or association at any place within the layout.

2. The use of the said manipulable field names in variable groupings or associations as a business method as a means of locating, comparing, and selecting products for retrieval, review, and purchase.

3. A system for organizing, processing, locating, and comparing products appropriate to the user's specific needs comprising:
a. a computer terminal connected to the internet,
b. a storage means for storing data on a digital or electronic storage medium,
c. an algorithmic logic circuit configured to prepare the storage medium to store the data,
d. an algorithmic logic circuit for locating the stored product and product specification data,
e. an algorithmic logic circuit by which the stored data may be associated with one or more field names or headings,
f. an algorithmic logic circuit for retrieval and display of located data in a user-manipulated spreadsheet display layout in which the fields as named or described by their various headings may be located at any place or no within the spreadsheet display,
whereby specific data for a given product may be compared with like data for other products of a like kind, without the restrictions imposed by a fixed layout for fixed fields, by means of infinitely manipulable fields, each with its own associated data records, which may be displayed in infinitely variable groupings or associations at any place within the layout.

4. The said data processing system of claim #3 further used as a business method as a means for enabling the user to retrieve, review and compare for purchase products of a like kind, by displaying only those specific characteristics of the products being considered that are relevant to the intended application of the product while bypassing those which are not germane to the application.

5. The said data processing system of claim #3 further used as a means of automatically changing parameter groupings and associations and the associated data displayed according to product type, in conjunction with the selection by the User of a new product type within the display layout.

6. The said data processing system of claim#3 further used as a means of storing unlimited amounts of data and displaying it in unlimited variations of parameter fields applied to unlimited types of products.

7. The said data processing system of claim # 3 further used as a component of internet navigation systems other than those covered by patents owned or claimed by World.info, as a means for enabling the user to retrieve, review and compare for purchase specific products of a like kind.

8. The said algorithmic logic programming language enabling all of the logic circuits of claim #3 as a means for enabling of the data processing system described in claim #3 above.

9. It should be understood that the following variations and modifications are intended to be included within the scope of the invention.
a. Additions or subtractions of attributes or parameters or renaming of attributes or parameters can be made to this system without departing from the spirit and scope of the invention
b. Using alternate field names for parameter or attribute can be done without departing from the spirit and scope of the invention.
c. The term “product” is construed to apply to any conceivable marketable item, object, service, performance, or idea. Its use includes, but is not limited to, industrial and other products, events and information such as industrial products, fish ponds, county fairs, travel information, government contracts, international trade opportunities etc.
d. Any division of any level within the hierarchy may be located using verbal, alpha, alphanumeric or numeric identifiers without departing from the spirit and scope of the invention.

10. Unique systems and methods of navigation and display will be filed in subsequent patents. However, this invention can also be navigated and displayed using the current art.
